(19) United States
(12) Patent Application Publication
(10) Pub. No.: US 2014/0006054 A1
(43) Pub. Date: Jan. 2, 2014

(54) SEGREGATION SYSTEM

(71) Applicant: Cardiocom, LLC, Chanhassen, MN (US)

(72) Inventors: Daniel L. Cosentino, Excelsior, MN (US); Christopher T. Abrahamson, Bloomington, MN (US); Kristin N. Parrott, Jordan, MN (US)

(21) Appl. No.: 13/920,718

(22) Filed: Jun. 18, 2013

Related U.S. Application Data
(60) Provisional application No. 61/661,212, filed on Jun. 18, 2012.

(51) Int. Cl. G06F 19/00

(52) U.S. Cl. CPC G06F 19/322
USPC 705/3

(57) ABSTRACT

Methods and systems for reviewing and segregating data are disclosed. An example system includes a remote patient monitoring apparatus, a health care communication device, and a central processing unit including a flagging and filtration system and a database storing a rule set. An example method includes receiving patient data from a remote location, storing the patient data in a database, flagging the patient data based on a predefined rule set, presenting the patient data to a health care professional for verification, updating the patient data in the database to reflect any changes made during health care professional verification, and transmitting at least a portion of the patient data to a client.

### CROSS REFERENCE TO RELATED APPLICATION

This application claims the benefit of U.S. Provisional Application No. 61/661,212, filed on Jun. 18, 2012, the disclosure of which is hereby incorporated by reference in its entirety.

### BACKGROUND

Caregivers frequently wish to review a wide range of patient health information to determine a health status of a patient. Meeting with a patient to gather this information (e.g., patient measurements, biometrics, and the like) often requires resources such as time and money for both the caregiver and the patient. Receiving patient medical information from a remote patient is more convenient; however, massive quantities of patient data may be received from each patient. Additionally, it is sometimes difficult to assess the quality and accuracy of the received patient data.

### Segregation System

In general terms, this disclosure is directed to systems and methods for receiving patient data from one or more remote patients. The received data is automatically categorized and flagged based on a set of configurable business rules. The categorized data can then be reviewed and verified by a health care professional prior to transmitting the reviewed data to a third-party client.

It should be appreciated that aspects the above-described subject matter may be implemented as a computer-controlled apparatus, a computer process, a computing system, a network of communicating computing systems, or as an article of manufacture such as a computer-readable storage medium. These and various other features will be apparent from a reading of the following Detailed Description and a review of the associated drawings.

This disclosure is provided to introduce a selection of concepts in a simplified form that are further described below in the Detailed Description. This disclosure is not intended to identify key features or essential features of the claimed subject matter, nor is it intended that this be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Reference will now be made to the accompanying drawings, which are not necessarily drawn to scale and wherein:

FIG. 1A is a block diagram illustrating an exemplary embodiment of a segregation system;

FIG. 1B is a block diagram illustrating another exemplary embodiment of a segregation system;

FIG. 2 is a schematic block diagram illustrating an exemplary architecture of a computing device for implementing aspects of the system shown in FIGS. 1A and 1B;

FIG. 3 is a table illustrating an exemplary embodiment of a patient data rule set use for implementing aspects of the segregation system;

FIG. 4 is an exemplary embodiment of a user interface used to implement aspects of the disclosure;

FIG. 5 is an exemplary embodiment of a user interface used to implement aspects of the disclosure;

FIG. 6 is an exemplary embodiment of a user interface used to implement aspects of the disclosure;

FIG. 7 is an exemplary embodiment of a user interface used to implement aspects of the disclosure;

FIG. 8 is an exemplary embodiment of a user interface used to implement aspects of the disclosure;

FIG. 9 is an exemplary embodiment of a user interface used to implement aspects of the disclosure; and

FIG. 10 is a flow chart illustrating an exemplary embodiment of a method of flagging, filtering, and verifying healthcare information.

### DETAILED DESCRIPTION

In general, the present disclosure describes systems and methods for segregating data. These systems are, for example, used for flagging, filtering, and verifying healthcare information, such as patient data, prior to transmission of the data to a client. For example, embodiments described below may enable patient data, collected from various patient input devices to be automatically filtered and/or categorized into one of several categories based on a set of pre-determined rules. Thereafter, health care professionals (e.g., nurses, caregivers, care coordinators, physicians, etc.) may verify the filtered and/or categorized data via a graphical user interface which enables quick and efficient review of the data. The reviewed data may then be transmitted to a client (hospitals, patient physicians, patient caregivers, patients, etc.) for review and/or incorporation into client-maintained records.

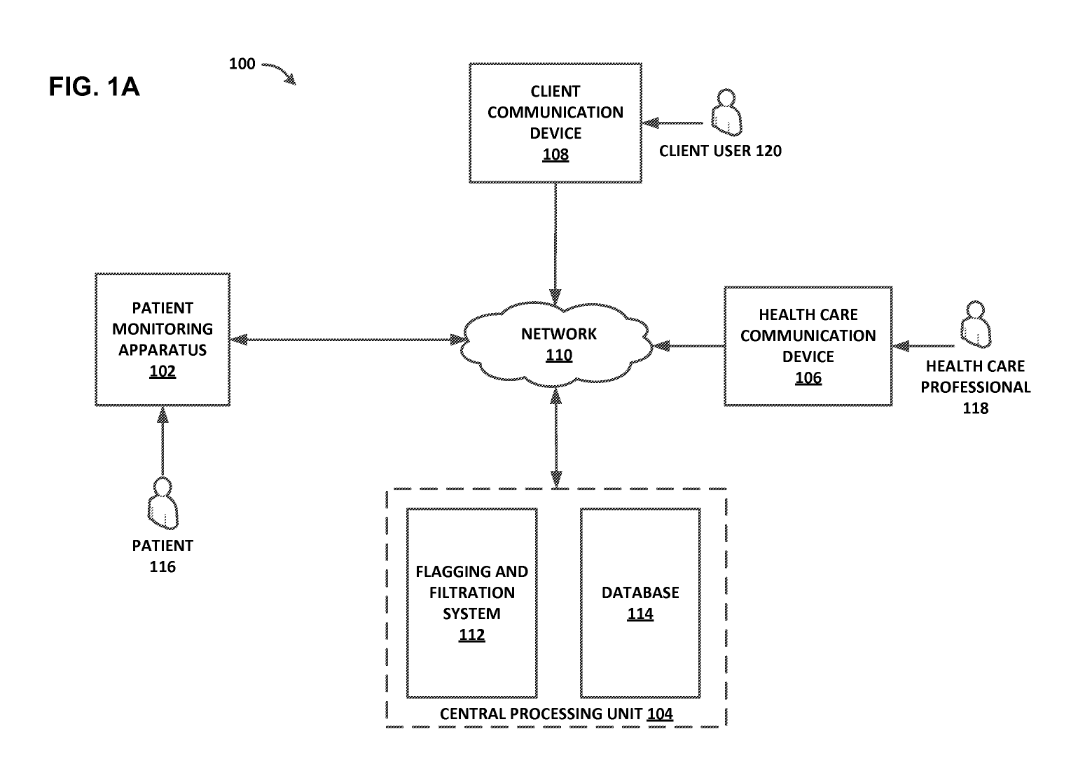

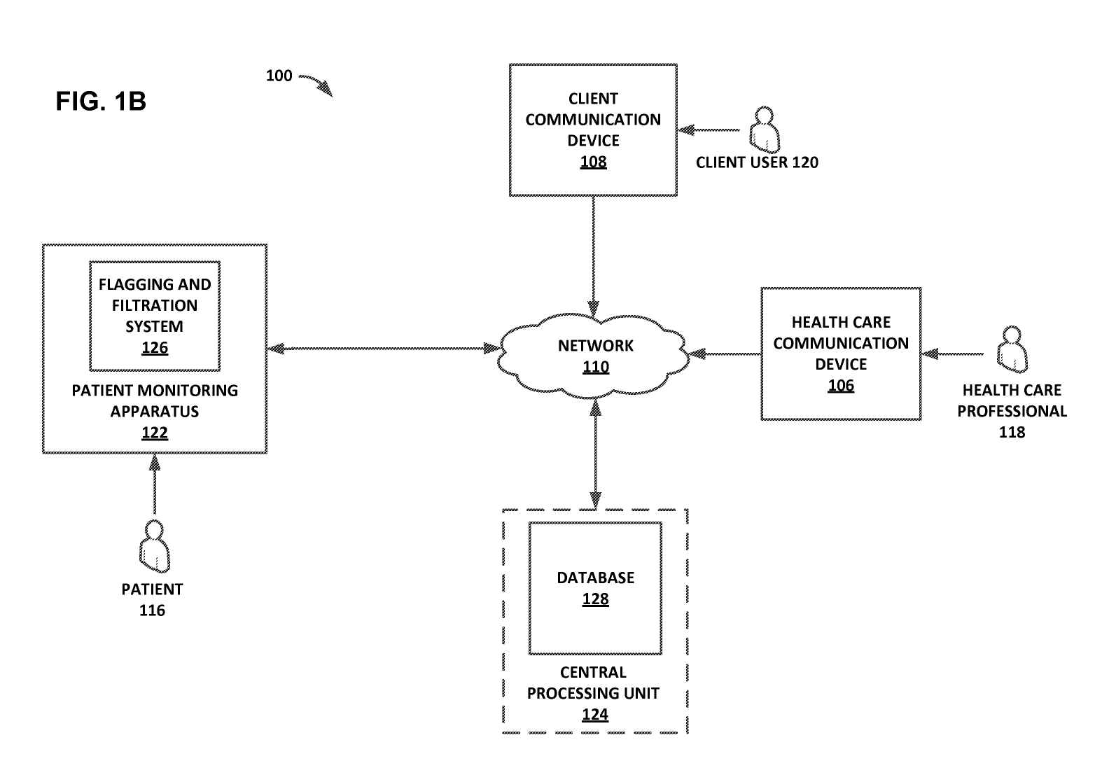

Referring now to FIGS. 1A and 1B, two alternative embodiments of a system 100 for segregating data is provided. More specifically, as shown in the FIG. 1A, the system 100 can be used for flagging, filtering, and verifying of healthcare information. For example, the system 100 includes a patient monitoring apparatus 102, a central processing unit 104, a healthcare communication device 106, a client communication device 108, and one or more networks 110. The central processing unit 104 includes a flagging and filtration system 112 and a database 114. A patient 116, a healthcare professional 118, and a client user 120 may access the patient monitoring apparatus, the healthcare communication device 106, and the client communication device 108, respectively.

In the alternate embodiments of the system 100 of FIG. 1B, patient monitoring apparatus 122 is one example of the patient monitoring apparatus 102, and central processing unit 124 is one example of the central processing unit 104. It is understood that the systems of FIGS. 1A and 1B generally operate in the same or similar ways, unless distinguished below.

Each of the patient monitoring apparatus 102, the client communication device 108, and the health care communication device 106 is capable of directly and/or indirectly communicating with the central processing unit 104 across one or more networks 110. The networks 110 can comprise any of a number of different combinations of one or more different types of networks. For example, the networks 110 can include one or more data private and/or public networks, such as a local area network (LAN), a metropolitan area network (MAN), and/or a wide area network (WAN) (e.g., Internet), can include one or more wireline and/or wireless voice networks including a wireline network, such as a public-switched telephone network (PSTN), and/or wireless networks. For purposes of illustration and simplicity, however, as described below, the network comprises the Internet (i.e., WAN) unless otherwise noted.

The patient monitoring apparatus 102, the central processing unit 104, the healthcare communication device 106, and the client communication device 108 can comprise any one or more of a number of different entities, devices, or the like capable of operating in accordance with embodiments described herein. In this regard, one or more of the patient monitoring apparatus 102, the central processing unit 104, the healthcare communication device 106, and the client communication device 108 can comprise, include or be embodied in one or more processing elements, such as one or more of a laptop computer, desktop computer, server computer or the like. Additionally or alternatively, one or more of the patient monitoring apparatus 102, the central processing unit 104, the healthcare communication device 106, and the client communication device 108 can comprise, include, or be embodied in one or more portable electronic devices, such as one or more of a mobile computing device such as a smart telephone (e.g., iPhone), portable digital assistant (PDA), electronic tablet, pager, tablet computer, laptop computer, or the like. For example, the patient monitoring apparatus 102, the central processing unit 104, the healthcare communication device 106, and the client communication device 108 can each comprise a processing element capable of communicating with one another across the Internet (i.e., network 110).

The patient monitoring apparatus 102 may be located in the home of an ambulatory patient, or in some other location that is easily accessible to the patient 116. Generally, the patient monitoring apparatus 102 may be any device capable of receiving, as an input, patient healthcare information. Alternatively, the patient monitoring apparatus 102 may be any device capable of sensing patient healthcare information, automatically or manually. In one embodiment, the patient monitoring apparatus 102 is configured to monitor patient wellness parameters of the patient 116, and then transmit these patient healthcare data indicative of patient wellness parameters to the central processing unit 104. Other examples of patient healthcare data include patient vital sign data and other patient data measurements such as blood pressure measurements, blood glucose measurements, ECG measurements, weight measurements, pulse oxygen, blood oxygen measurements, pain, mood, heart rate, heart pulse, peak flow, and any other measurements or biometrics. In addition, patient healthcare data may include patient answers to health-related questions.

Although not shown in the figure, it is understood that more than one patient monitoring apparatus may be present in the system. The patient monitoring apparatus may be any device capable of receiving health data from a patient, including any measurement collecting or monitoring device, interactive voice recognition (“IVR”) system by which a patient may interact with the system and respond with patient health information, telephone, cell phone, tablet, any other computer, or the like. It is further understood that the system may monitor a plurality of patients. Each of the plurality of patients may interact with one or more monitoring devices which transmit data to the central processing unit 104.

In the example, the central processing unit 104 includes the flagging and filtration system 112 and the database 114. In the embodiment, patient healthcare information is transmitted from the patient monitoring apparatus 102 to the central processing unit 104 via the network 110. At the central processing unit 104, the healthcare data is filtered at the flagging and filtration system 112. For example, the data may be categorized based on pre-determined rule sets defining valid ranges for patient data. The pre-determined rule sets may be saved in the database 114, the flagging and filtration system 112, the central processing unit 104, or the patient monitoring apparatus 102. In some embodiments, based upon the rule sets, the data may be automatically categorized into one of a plurality of categories. Examples of categories include, but are not limited to, “Accurate,” “Possibly Inaccurate,” “Inaccurate,” and “Impossible.” In alternate embodiments, the patient monitoring apparatus may include the flagging and filtration system, as shown in FIG. 1B. In such an embodiment, the patient information is filtered and categorized utilizing the same methods as those described above prior to being transmitted to the central processing unit 124.

The categorized patient information is stored in the database 114, 128, respectively, until it is reviewed by the health care professional 118 and/or transmitted to the client communication device 108. The database 114 may also include prior patient data which may be accessed for purposes of particular rules sets, as will be discussed below. The healthcare professional 118 may directly access the patient data stored in the database 114 or indirectly access the patient data by utilizing the healthcare communication device 106 to connect to the central processing unit 104, 124, respectively, via the network 110. The healthcare professional 118 may then access the patient information stored in the database 114, 128, respectively, to review, verify, and/or modify the categorizations of the patient information. The patient information that is reviewed and verified by the healthcare professional 118 is then transmitted to the client communication device 108. In some embodiments, the patient information that is flagged as “Inaccurate” and “Impossible,” is not transmitted to the client communication device 108. In other embodiments, all patient information is transmitted to the healthcare professional 118, however, the patient information that is flagged as “Inaccurate” and “Impossible” is not incorporated into any cumulative patient data reports, graphs, or other data summarizing methods due to its likelihood to skew the results. The rules regarding data transfer of this nature may be configurable by any members of the system 100. Alternatively, default rules set by an administrator may be utilized. The client communication device 108 may then incorporate the transmitted patient information into a client-maintained patient record and/or alert the client user 120 to review the newly transmitted patient information to determine a health status of the patient 116.

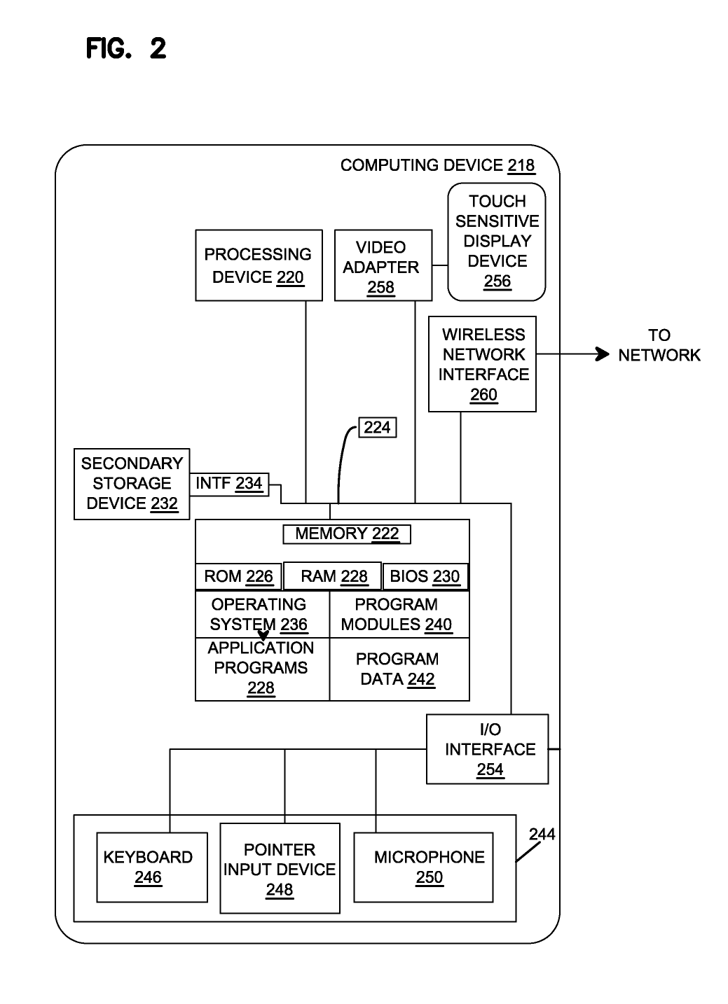

FIG. 2 illustrates an exemplary architecture of a computing device that can be used to implement aspects of the present disclosure, including the patient monitoring apparatuses 102, 122, the central processing units 104, 124, the healthcare communication device 106, and the client communication device 108 and will be referred to herein as the computing device 202. The computing device 202 is used to execute the operating system, application programs, and software modules, described herein.

The computing device 202 includes, in some embodiments, at least one processing device 220, such as a central processing unit (CPU). A variety of processing devices are available from a variety of manufacturers, for example, Intel or Advanced Micro Devices. In this example, the computing device 202 also includes a system memory 222, and a system bus 224 that couples various system components including the system memory 222 to the processing device 220. The system bus 224 is one of any number of types of bus structures including a memory bus, or memory controller; a peripheral bus; and a local bus using any of a variety of bus architectures.

Examples of computing devices suitable for the computing device 202 include a desktop computer, a laptop computer, a tablet computer, a mobile phone device such as a smart phone, or other devices configured to process digital instructions.

The system memory 222 includes read only memory 226 and random access memory 228. A basic input/output system 230 containing the basic routines that act to transfer information within computing device 202, such as during start up, is typically stored in the read only memory 226.

The computing device 202 also includes a secondary storage device 232 in some embodiments, such as a hard disk drive, including magnetic and solid state drives, for storing digital data. The secondary storage device 232 is connected to the system bus 224 by a secondary storage interface 234. The secondary storage devices and their associated computer readable media provide nonvolatile storage of computer readable instructions (including application programs and program modules), data structures, and other data for the computing device 202.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media.

A number of program modules can be stored in secondary storage device 232 or memory 222, including an operating system 236, one or more application programs 238, other program modules 240, and program data 242.

In an exemplary embodiment, the data stored in program data 242 can be represented in one or more files having any format usable by a computer. Examples include text files formatted according to a markup language and having data items and tags to instruct computer programs and processes how to use and present the data item. Examples of such formats include html, xml, and xhtml, although other formats for text files can be used. Additionally, the data can be represented using formats other than those conforming to a markup language.

In some embodiments disclosed herein, findings are stored as data items in one or more data records. In some embodiments, data records are a set of one or more data items, such as in a format that can be read by a computing device. An example embodiment is a database record. Other examples of data records include tables, text files, computer executable files, data structures, or other structures for associating data items.

In some embodiments, computing device 202 includes input devices to enable inputs to the computing device 202. Examples of input devices 244 include a keyboard 246, pointer input device 248, microphone 250, and touch sensitive display 256. Other embodiments include other input devices 244. The input devices are often connected to the processing device 220 through an input/output interface 254 that is coupled to the system bus 224. These input devices 244 can be connected by any number of input/output interfaces, such as a parallel port, serial port, game port, or a universal serial bus. Wireless communication between input devices and interface 254 is possible as well, and includes infrared, BLUETOOTH® wireless technology, 802.11a/b/g/n, cellular, or other radio frequency communication systems in some possible embodiments.

In some embodiments, a touch sensitive display device 256 is also connected to the system bus 224 via an interface, such as a video adapter 258. The touch sensitive display device 256 includes touch sensors for receiving input from a user when the user touches the display. Such sensors can be capacitive sensors, pressure sensors, or other touch sensors. The sensors not only detect contact with the display, but also the location of the contact and movement of the contact over time. For example, a user can move a finger or stylus across the screen to provide written inputs. The written inputs are evaluated and, in some embodiments, converted into text inputs. It is understood that all user selections described herein may be conducted by utilizing a finger to select or move an item on the touch sensitive display device 256. The touch sensitive display can use various different technologies such as resistive, surface acoustic wave, capacitive, infrared grids, projected optical imaging, dispersive signaling, and any other suitable touch technology. User interfaces displayed on the touch sensitive display device 256 can be operated with other types of input devices such as a mouse, touchpad, or keyboard. Other embodiments can use a non-touch display that is operated with an input device such as a mouse, touchpad, keyboard, or other type of input device.

In addition to the display device 256, the computing device 202 can include various other peripheral devices (not shown), such as speakers or a printer.

When used in a local area networking environment or a wide area networking environment (such as the Internet), the computing device 202 is typically connected to the network through a network interface, such as a wireless network interface 260. Other possible embodiments use other communication devices. For example, some embodiments of the computing device 202 include an Ethernet network interface, or a modem for communicating across the network.

The computing device 202 typically includes at least some form of computer-readable media. Computer readable media includes any available media that can be accessed by the computing device 202. By way of example, computer-readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 202.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

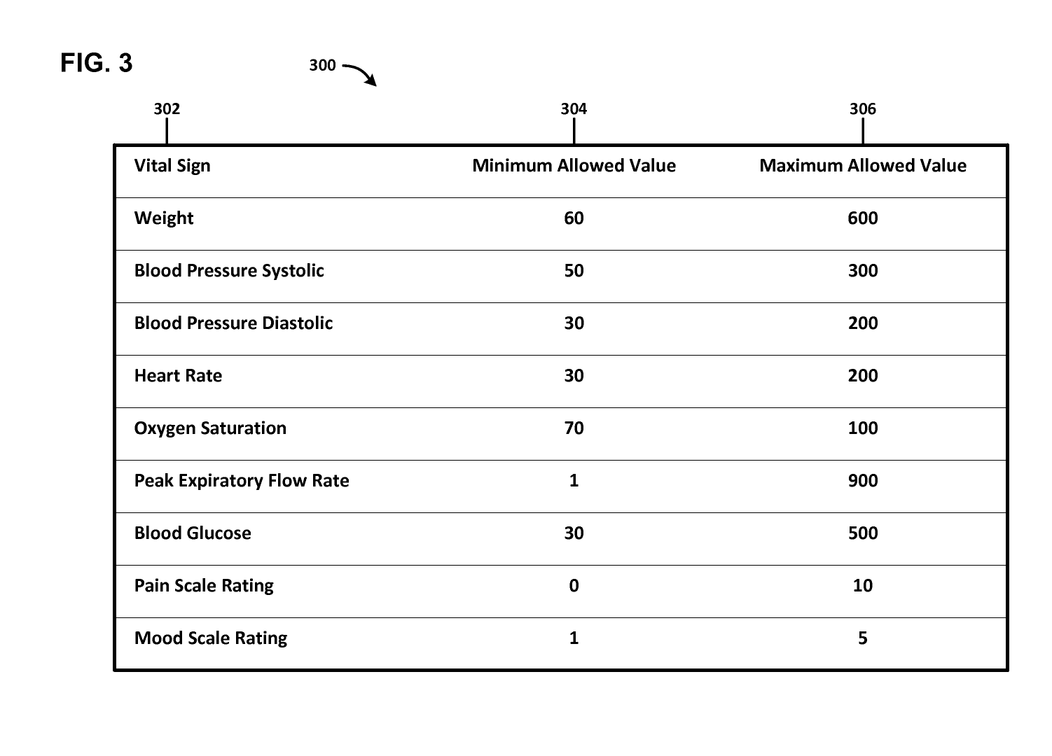

FIG. 3 illustrates one embodiment of a rule set table 300. The rule set table 300 includes a column indicating a vital sign 302, a column indicating a minimum allowed value 304, and a column indicating a maximum allowed value 306. The rule set table 300 includes guidelines for filtration of any patient data including a measurement related to a vital sign in the column 302.

In the example, the rule set table 300 may be one of multiple layers of filtration guidelines that are imposed by the system 112. The rule set table 300 may be pre-established by and/or configured for later modification by the central processing unit 104, the healthcare communication device 106, the healthcare professional 118, or any administrator of the system 100. A rule set table, such as the rule set table 300, may be presented on any of the above components or presented to any of the above individuals via said components for initial configuration or modification. In yet other embodiments, the system 112 may have default rule sets that cannot be altered, or can only be partially altered. It is also understood that rule sets may be presented in alternate forms, such as via any data structure (e.g., matrix, list, table, chart, etc.) or via simple text without the use of any data structure.

Once the rules are set, data received at the system 112 is filtered by the appropriate vital sign rule and categorized based on the results. For example, if a patient weight of “50” is sent to the present system, the system 112 would utilize the rule set table 300 and determine that the patient weight falls below the minimum allowed value in column 304. Thereafter, based on the system settings, the patient weight may be flagged within a category, such as, for example, “Impossible,” “Inaccurate,” or “Possibly Inaccurate.”

It is understood that the number of defined categories (e.g., “Accurate”, “Inaccurate,” “Possibly Inaccurate,” “Impossible”, etc.), the type of defined categories, and the categorization guidelines are dependent on pre-established (prior to categorization) rules determined by the central processing unit 104, the healthcare communication device 106, the healthcare professional 118, or any administrator of the system 100. It is further understood that the minimum and maximum allowed values in columns 304, 306 are simply examples, and can be set to various different settings/values as determined by the person or entity defining the rule set.

The system 112 may utilize various other rule sets for categorizing data. For example, in some embodiments, rules may be generated which require the system to compare a present data measurement with a previously stored data measurement and determine whether the difference between the measurements is acceptable by the system, and categorize the measurement based on this difference. Furthermore, other rule sets may relate to the date and time at which the patient data was monitored and/or received. For example, in one embodiment, a rule may exist wherein data marked with a future date is flagged as “Impossible” or “Inaccurate.” In other embodiments, a rule may state that data marked more than a predetermined amount of days in the past should be flagged as “Possibly Inaccurate” or “Inaccurate.” In some embodiments, the system displays the date/time in the time zone of the patient when the measurement was taken. In alternate embodiments, the system displays the date/time in the time zone of the health care professional when the measurement was transmitted.

In some embodiments, patient information may be automatically flagged within a certain category during a level of filtration. For example, rules may be created in which data received from a patient monitoring device that has a date/time which is automatically and regularly set from a national date/time standard is automatically marked as “Accurate.” Another rule may exist where any patient information that was manually entered is automatically categorized as “Inaccurate,” or “Possibly Inaccurate.” Yet another rule may exist where any patient information received from a particular device is automatically categorized as “Possibly Inaccurate.”

Other rules sets may define how particular measurements are categorized. For example, a particular rule may state that a weight that is a certain percentage or a number of pounds above or below a previously taken weight should be marked as “Inaccurate” or “Possibly Inaccurate.” In some embodiments, the database 114 stores previously taken measurements for a predetermined amount of time for purposes of later analysis and use with the rule sets. Other rules may indicate that measurements must be within a predefined range to be flagged as “Accurate.” Another rule may state that a measurement that is a certain percentage above or below the average of the last predetermined amount of similar measurements should be categorized in a certain group. It is understood that the above examples of rule sets are merely exemplary, and various other rule sets may be configured, as discussed above.

It is important to note that though data may be marked within a certain category in a first level of filtration, the data may later be flagged in a different category after passing through various other levels of filtration. For example, a first level of filtration may include rule sets relating to date and time accuracy. A second level of filtration, however, may include rule sets relating to minimum and maximum allowed values for vital signs, such as the rule set table 300. Therefore, even if data is marked as “Accurate” by the date/time rule set table, the same data may be later marked as “Inaccurate” after passing through a vital sign value rule set. The number of layers of filtration may be based on system defaults or the entity or individual defining the rule set. In alternate embodiments, the patient information may pass through various layers of filtration without being categorized into any category.

After the patient information passes through the various layers of filtration rule sets, the categorized patient information is stored in the database 114 until it is reviewed by the health care professional 118 and/or transmitted to the client communication device 108.

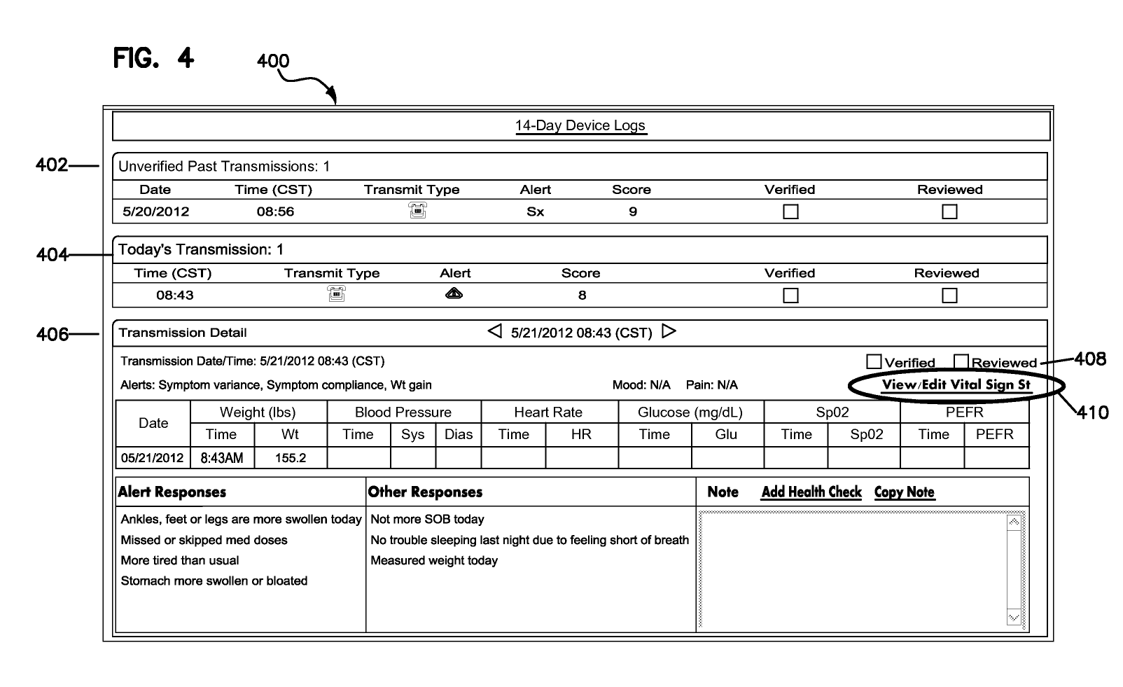

FIG. 4 shows an example user interface 400 by which a user, such as the healthcare professional 118 may view and interact with data that is categorized based on a rule set, such as the rule set discussed in FIG. 3. The user interface 400 enables the healthcare professional 118 to view unverified past transmissions 402, current transmissions 404, and details of each transmission 406. In the example, the healthcare professional 118 has an option to mark each transmission as verified or reviewed via user buttons 408. The healthcare professional 118 can also view and/or edit vital sign categorizations via a link 410.

The user interface 400 provides a basic summary of any transmissions from a patient monitoring apparatus, such as patient monitoring apparatus 102. In some embodiments, such as in the user interface 400, unverified data is marked as unverified so that it is brought to the attention of the health care professional 118. As stated above, in certain embodiments, data is not transmitted to a client, such as the client 108 without first being verified by the health care professional 118. The healthcare professional 118 may click the link 410 to view details of each transmission. In this way, the healthcare professional 118 may determine whether the data was properly categorized by the flagging and filtration system 112.

In the example embodiment, the healthcare professional 118 may either verify each measurement transmitted via one click of user buttons 408 (e.g., selecting “verified” and/or “reviewed”). However, if upon glancing at the details of each transmission 406, the health care professional 118 would like to review the categorizations of each measurement, the healthcare professional 118 has this option. To expedite this process for the healthcare professional 118, in some embodiments, one or more measurements in the details of each transmission 406 may be color coded to indicate a categorization. In particular, questionable transmissions may be flagged in a particular color to attract the attention of the health care professional 118.

For example, in the user interface 400, one patient measurement is transmitted at the date and time written in the details of each transmission 406. If the patient measurement has been categorized by the system to be “Accurate,” the measurement may appear green. If the patient measurement has been categorized by the system to be “Inaccurate,” the measurement may appear red. And, if the patient measurement has been categorized by the system to be “Possibly Inaccurate,” the measurement may appear yellow. It is understood that the color coding discussed herein is merely exemplary, and any range of color may be utilized by the system either based on default options of the system or on configurable options, as discussed above.

The system may alternatively or additionally utilize fonts, highlighting, pictures, and the like to communicate a certain category. For example, the system may indicate to the health care professional 118 that a transmission has been categorized as “Possibly Inaccurate” by including an icon at some position on the user interface 400 which attracts the attention of the health care professional 118.

The example user interface 400 may be the first screen shot presented to the healthcare professional 118 or a screen shot that is viewed after the healthcare professional 118 has selected an option on a previous screen shot. For example, the user interface 400 may be transmission history and current transmissions of a particular patient. A prior screen shot may have included a listing of several patients, of which the healthcare professional 118 chose one patient. This is particularly relevant when more than one patient may transmit data from remote patient apparatuses at or around the same time.

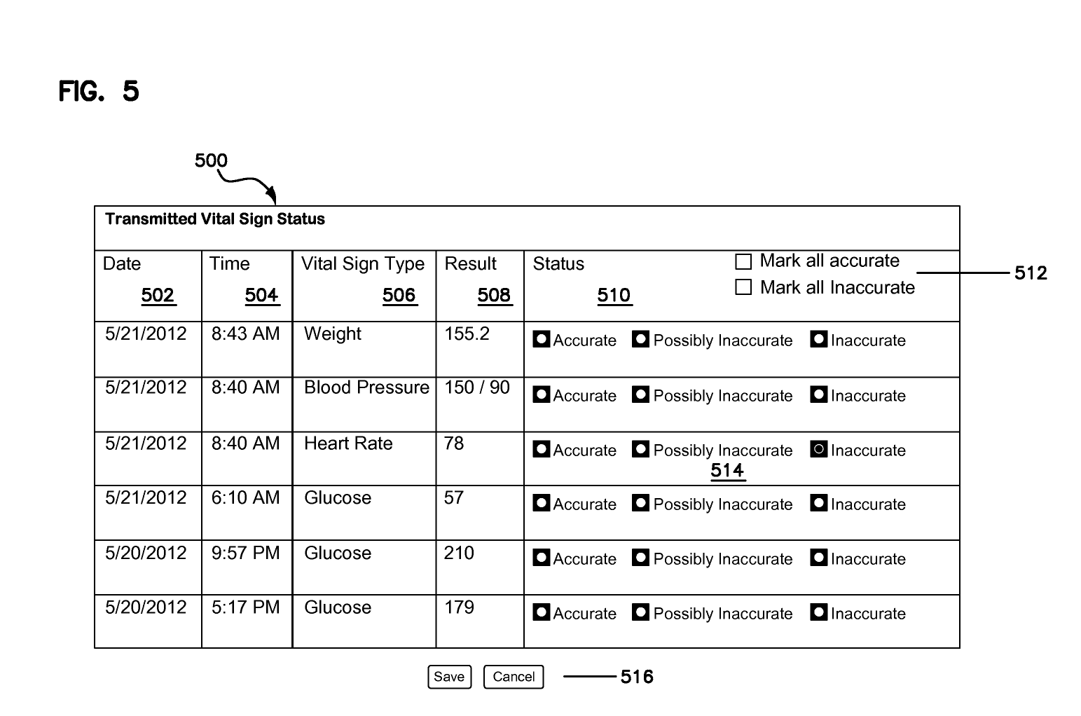

FIG. 5 is an example user interface 500 which is displayed to the healthcare professional 118 upon clicking the link 410 the user interface 400 (FIG. 4). The user interface 500 includes a date column 502, a time column 504, a vita sign type column 506, a result column 508, and a status column 510. The status column 510 includes user selection buttons 512, 514, and 516.

The user interface 500 allows the healthcare professional 118 to view the details of each patient information transmission between the patient monitoring apparatus 102 and the central processing unit 104. The healthcare professional 118 can view the date and time at which the data was received and/or monitored, the type of data, the data measurement, the available categories of classification, and whether the system 112 categorized the data into a specific group based on the pre-established rule sets. In alternate embodiments, various other columns of information may be presented to the healthcare professional 118, such as, which rule triggered the categorization if any, a history of patient measurements, patient health information not relating to vital sign data (e.g., patient answers to health-related questions), the name or username of the last user who edited a flag, the time of the last edit, a historical record of previous edits, and any other information that may be helpful for the healthcare professional 118 to view prior to transmission to the client communication device 108.

The healthcare professional 118 may utilize the user interface 500 to review the patient information and determine whether data is properly categorized. The healthcare professional 118 can also determine the categorization of any un-categorized data. Thus, for example, in the user interface 500, the healthcare professional 118 may individually utilize user selection buttons 514 to mark each column of data as either “Accurate,” “Possibly Inaccurate,” or “Inaccurate.” It is understood that in other examples, the predefined rule sets may define more or less of the same or different categories, and those categories would be listed in the user interface 500. To simplify the process, the healthcare professional 118 may utilize user selection buttons 512 to mark every row of data as “Accurate” or “Inaccurate,” in one selection. Upon completion of the review, the healthcare professional 118 can utilize the user selection buttons 516 to either save or cancel the status of the patient health information. In alternate user interfaces, the buttons 512, 514, and 516 may be any user input format which enables the healthcare professional 118 to communicate a selection, for example, radio buttons, multiple choice, a text-input block, or the like.

For purposes of simplicity, in some embodiments, the cells in the status column 510 may be shaded various colors to denote the categorization of the data. For example, in one embodiment, cells with data marked as “Accurate,” may be green, cells with data marked as “Possibly Inaccurate,” may be yellow, and cells with data marked as “Inaccurate,” may be red. As stated above with respect to color coding, the colors used herein are merely exemplary and alternate embodiments may utilize alternate colors.

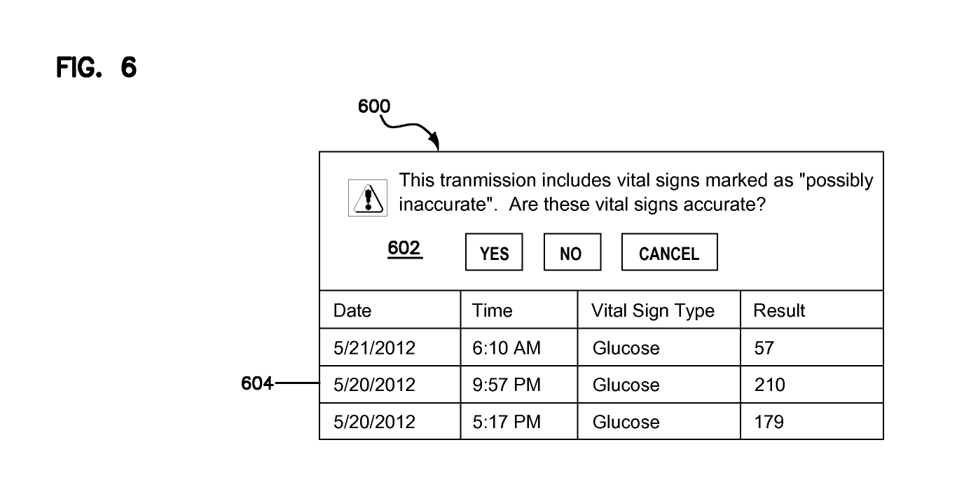

Upon reviewing and editing the categorization details in the user interface 500, the system may return to the user interface 400. At this time, the healthcare professional 118 may utilize user buttons 408 to mark the verified and reviewed buttons. If so, one of several actions may occur. In some situation, data flagged as “Accurate” may not require additional verification by the healthcare professional 118. However, in some embodiments, if the data is flagged as “Accurate,” and the healthcare professional 118 checks the “Verified” box, the system will note that the date has been verified and approved for transmission to the client 108. In other situations, the system may require the health care professional 118 to provide more information. For example, if the healthcare professional 118 checks the “Verified” box and the transmission still includes data flagged as “Possibly Inaccurate,” the health care professional 118 may be prompted to either confirm or deny the accuracy of the data, as shown below in FIG. 6. In some embodiments, it is the goal of the system to ensure that all data marked as “Possibly Inaccurate” is reviewed by a healthcare professional so that such data may be categorized into a more definitive categorization (e.g., “Accurate” or “Inaccurate”).

FIG. 6 shows a confirmation user interface 600. The user interface 600 includes a confirmation box 602 and patient information rows 604. In the embodiment, the healthcare professional 118 is requested to either confirm or deny the accuracy of the data within the patient information rows 604. As discussed above, the user interface 600 illustrates one example of a user interface that is presented to the healthcare professional 118 if the “Verified” box is checked in the user interface 500 when data is still flagged as “Possibly Inaccurate.”

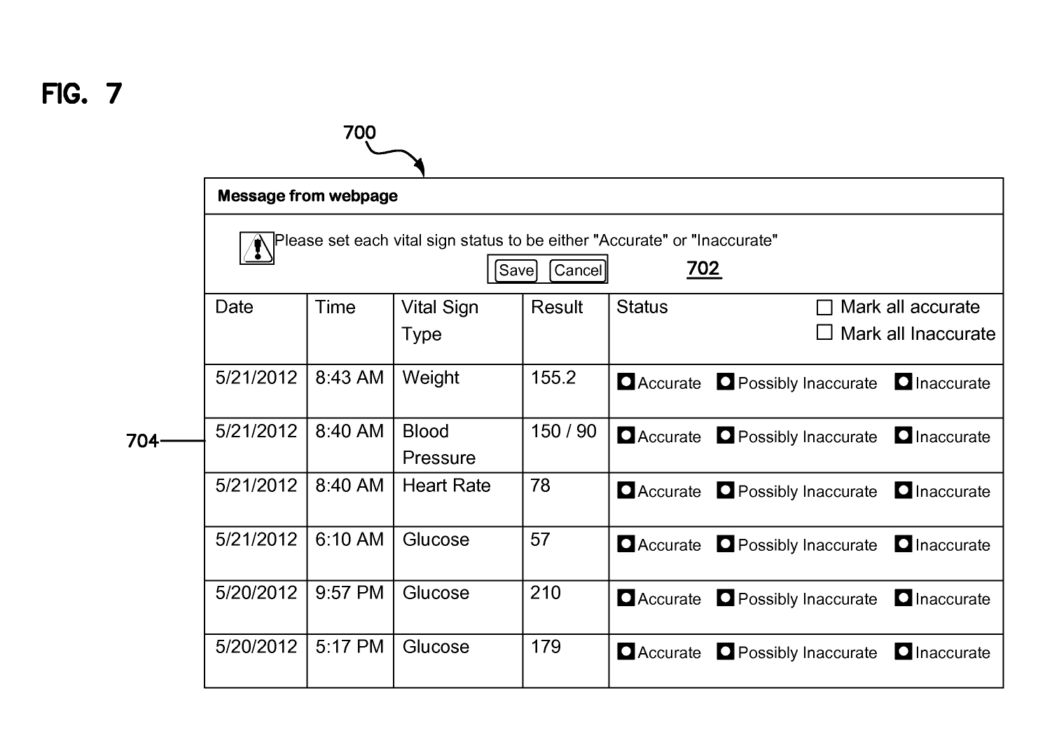

In some embodiments, if the healthcare professional 118 selects “CANCEL,” in the confirmation box 602, the window will close and the healthcare professional 118 will be referred back to the user interface 400 (or another user interface in which the health care professional 118 may interact with patient data). If the healthcare professional 118 selects “YES,” all statuses for the vital signs in patient information rows 604 will automatically be categorized to “Accurate.” Further, the user interface 600 may close and the “Verified” box would remain checked in the user interface 400. The system would then mark the data as verified and approved for transmission to the client 108. If, however, the healthcare professional 118 selects “NO,” the system may close the user interface 600 and require the healthcare professional 118 to update the statuses of any of the data in patient information rows 604, as shown in FIG. 7.

FIG. 7 shows a user interface 700. The user interface 700 includes a message 702 and patient information rows 704. The user interface 700 is one example of a user interface that is presented to the healthcare professional 118 in response to the user selecting “NO” on the user interface 600, indicating that all of the vital signs marked as “Possibly Inaccurate” are not accurate.

In the example, the healthcare professional 118 is given the option to change the categorization of one or more of the data in patient information rows 704. If the healthcare professional 118 selects “CANCEL,” the user interface 700 will close and healthcare professional 118 will be redirected to user interface 400, for example. In the embodiment, the “Verified” box at the user interface 400 will not be selected in this scenario.

If the health care professional 118 instead selects “SAVE” and none of the data in the patient information row 704 is marked as “Possibly Inaccurate,” the healthcare professional 118 will be redirected to the user interface 400 and the “Verified” box at the user interface 400 will be selected, for example. The system may then note that the data has been verified. In some embodiments, the data marked as “Accurate” would be approved for transmission to the client 108 while the data marked as “Inaccurate” would not be approved for transmission to the client 108. In some embodiments, the data marked as “Accurate” would then be automatically transmitted to the client 108, while data marked as “Inaccurate” would be discarded. In other embodiments, data in both categories, “Accurate” and “Inaccurate,” may be sent to the client 108, however, data flagged as “Inaccurate” may not be incorporated into any cumulative patient data reports, graphs, or other data summarizing methods due to its likelihood to skew or negatively impact the results. In yet further embodiments, the data flagged as “Inaccurate” may be sent to the client 108 but clearly marked as “Inaccurate” so as to alert the client 108 of possible inaccuracies. In even further embodiments, the predefined rule set may be configured by the client 108 or an individual associated therewith. In some embodiments, the client may configure the rule set to automatically or manually transmit all information to the client 108 without any verification or review by the healthcare professional 118.

If the health care professional 118 instead selects “SAVE” on the user interface 700 and one or more of the data transmissions in the patient information row 704 are marked as “Possibly Inaccurate,” the system may alert the health care professional 118 of the error.

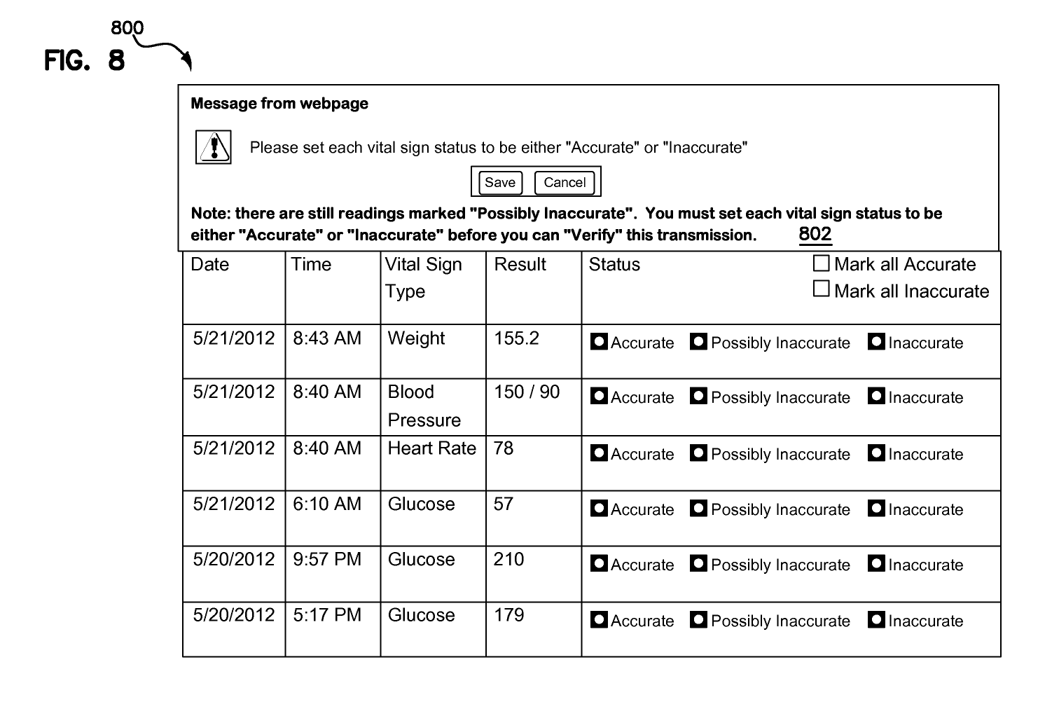

FIG. 8 is one example of an alert screen 800 that is presented to the health care professional 118 if one or more of the data transmissions in the patient information row 704 of FIG. 7 are marked as “Possibly Inaccurate.” The alert may be communicated via a text message 802 on the user interface 800.

An example of the error message displayed on the screen 800 is, “Note: there are still readings marked ‘Possibly Inaccurate.’ You must set each vital sign status to be either ‘Accurate’ or ‘Inaccurate’ before you can ‘verify’ this transmission.” It is important to note that the error message may include any message, sound, color, or combination thereof, to alert the healthcare professional 118 of the error. Alternatively, in some embodiments, the system may not present an alert. Instead, the system may simply not allow the healthcare professional 118 to verify the transmission at user interface 400.

If the healthcare professional 118 selects “CANCEL” at user interface 800, in some embodiments, the window will close and the healthcare professional 118 will be redirected to user interface 400 where the “VERIFIED” box will not be selected. Alternatively, if the healthcare professional 118 selects “SAVE” at user interface 800, and all readings are marked as either “Accurate” or “Inaccurate,” the “VERIFIED” box will be checked at user interface 400 and the system will note that the data is verified. If however, the healthcare professional 118 selects “SAVE” and one or more patient readings are marked “Possibly Inaccurate,” the system may not allow the user to leave the user interface 800, for example. In some embodiments, the message 802 may be appended to recite, “Unable to save. Data must be marked either ‘Accurate’ or ‘Inaccurate.’” It is understood that this message is merely exemplary, and any other alert may be utilized as discussed above. Further, in some embodiments, no alert is presented to the healthcare professional 118.

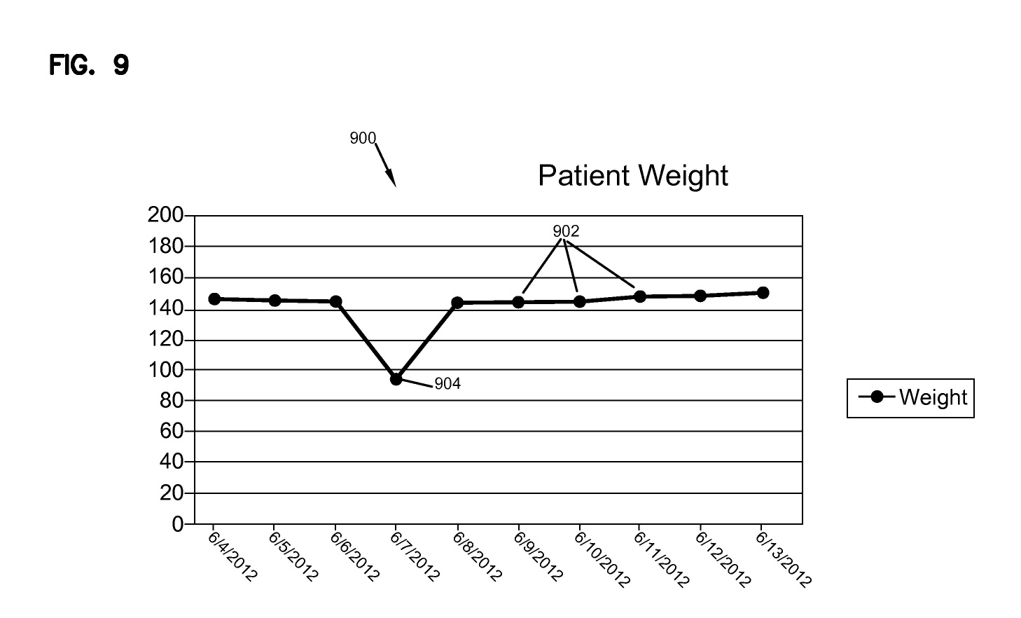

FIG. 9 illustrates a user interface 900. The user interface 900 is designed as a graph of data points 902. The user interface 900 is an alternate embodiment of an interface presented to the healthcare professional 118 to verify data points 902 of a particular patient over time. For example, the healthcare professional 118 may view the data in visual format and easily recognize data outliers, such as data point 904, which appear to be drastically different in measurement than other measurements taken on or around the same time. The healthcare professional 118 may utilize an input device, such as a mouse, to click on the outlier. At this point, the system may enable the healthcare professional 118 to review the details of the transmission, such as the categorization of the measurements, and edit the categorization of the data point 904.

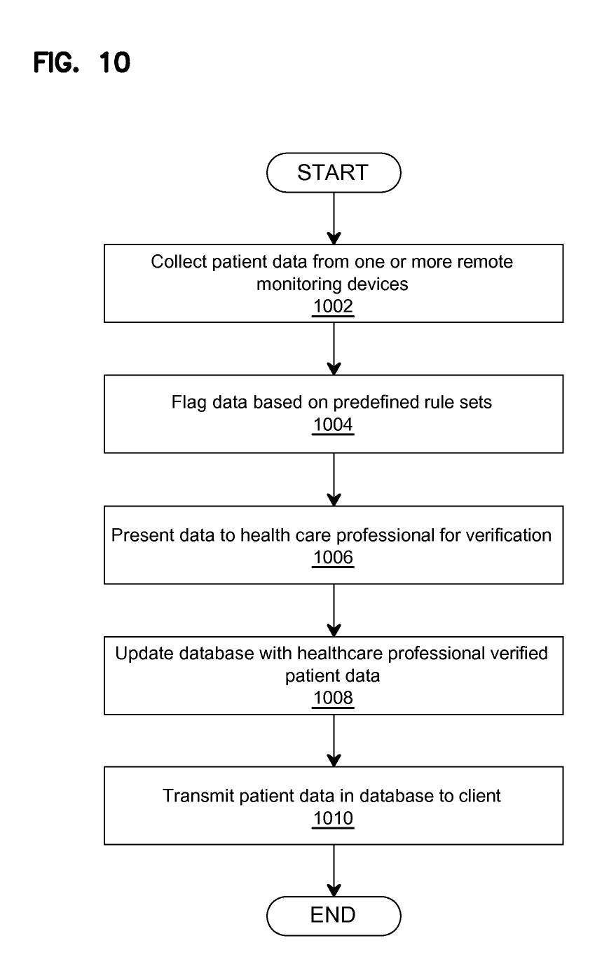

FIG. 10 is a flow chart 1000 which illustrates an example method of flagging, filtering, and verifying healthcare information.

The method 1000 begins at operation 1002 in which patient data is collected. The data may be collected by way of patient monitoring apparatus 102 or any other data collection device and/or data communication device. At operation 1004, the data is categorized based on pre-established rule sets, such as the rule set table 300. In other embodiments, the categorization occurs based on default rule sets determined by an administrator. Upon categorization, the data is presented to a healthcare professional for review and verification (operation 1006). As shown above, the data may be presented to the health care professional via various user interfaces. When reviewing the data, the healthcare professional may update the categorizations at operation 1008. In some embodiments, the healthcare professional may be required to update vague categorizations, such as “Possibly Inaccurate” or “Possibly Accurate.” However, in other embodiments, the healthcare professional may not be required to edit such categorizations. The verified categorizations are saved to the database.

Finally, at operation 1010, the reviewed and verified data for the patient is sent to a client. As stated above, the data may be sent to the client in a variety of different formats (e.g., charts, graphs, tables, lists, written formats). In some embodiments, only data flagged as “Accurate” is transmitted to the client. In yet further embodiments, all data is transmitted to the client, however, data flagged as “Inaccurate” may be brought to the client's attention and/or may not be included in any cumulative patient data reports, graphs, or other data summarizing methods due to its likelihood to negatively skew patient records.

In some embodiments, to ensure that all verified data is ready to be transmitted to the client, a waiting period may exist between when the healthcare professional verified the data and when the transmission to the client occurs. The waiting period may be any amount of time deemed appropriate by system administrators, including as short as a few minutes to as long as a few days. The waiting period may also be configurable in the rules set. The waiting period allows a health care professional or the like to correct unintentional or incorrect transmission verifications. Upon completion of the waiting period, all verification records may be locked and the system 100 may transmit the records to the client, as described above.

The system 100 may utilize various methods to transmit the data to the client, such as: HL7 messaging, XML, comma-delimited, other flat-file formatted document files, network-based transport such as custom protocols over TCP/IP, and/or any other compatible web-service interface. However, in some embodiments, data will not be sent to the client even after the waiting period, if the data has not yet been verified by a healthcare professional.

In some embodiments, after the data has been transmitted to a client, the healthcare professional 118 or the central processing unit 104 may be enabled to send updates to the data. Such updates may include adding additional data to a record, removing a record, editing a record, or changing an alert that may have been sent with the data.

In yet further embodiments, all data received from the patient at operation 1002 is transmitted to the client without any verification by a healthcare professional.

It will be clear that the systems and methods described herein are well adapted to attain the ends and advantages mentioned as well as those inherent therein. Those skilled in the art will recognize that the methods and systems within this specification may be implemented in many manners and as such is not to be limited by the foregoing exemplified embodiments and examples. In other words, functional elements being performed by a single or multiple components, in various combinations of hardware and software, and individual functions can be distributed among software applications at either the client or server level. In this regard, any number of the features of the different embodiments described herein may be combined into one single embodiment and alternative embodiments having fewer than or more than all of the features herein described are possible.

While various embodiments have been described for purposes of this disclosure, various changes and modifications may be made which are well within the scope of the present disclosure. Numerous other changes may be made which will readily suggest themselves to those skilled in the art.

What is claimed is:

1. A method for reviewing data, the method comprising:
receiving, at a computing device, patient data from a remote location;
storing, at the computing device, the patient data in a database;
flagging, at the computing device, the patient data based on a predefined rule set;
presenting, on the computing device, the patient data to a health care professional for verification;
updating, at the computing device, the patient data in the database to reflect any changes made during health care professional verification; and
transmitting, from the computing device, at least a portion of the patient data to a client.

2. The method of claim 1, wherein the predefined rule set is configurable by at least one of: a client and a user associated with the client.

3. The method of claim 1, wherein the predefined rule set is configurable by at least one of: the health care communication device and the health care professional.

4. The method of claim 1, wherein the patient data is associated with a date; and wherein the predefined rule set includes a rule indicating that when the date indicates a future date, the patient data is automatically flagged as inaccurate.

5. The method of claim 1, where in the patient data includes at least one of: a blood pressure measurement, a blood glucose measurement, an ECG measurement, a weight measurement, a pulse oxygen measurement, a blood oxygen measurement, a heart rate measurement, and a peak flow measurement.

6. The method of claim 1, wherein the patient data includes patient answers to health-related questions.

7. The method of claim 1, wherein flagging the patient data comprises:
organizing the each item of data in the patient data into at least one of: an accurate category, an inaccurate category, a possibly accurate category, an impossible category, and a possibly inaccurate category.

8. The method of claim 1, wherein presenting the patient data comprises:
presenting each item of data in the patient data in at least one of a plurality of categories; and
color-coding each of the plurality of categories differently to distinguish the plurality of categories.

9. The method of claim 1, wherein at least a portion of the data includes all of the data flagged as accurate.

10. The method of claim 1, wherein updating the patient data comprises changing all of the data flagged as possibly inaccurate and possibly accurate to at least one of accurate and inaccurate based on the changes made during the health care professional verification.

11. A system for reviewing data, the system comprising:
a remote patient monitoring apparatus;
a central processing unit, the central processing unit including a flagging and filtration system and a database storing a predefined rule set, the flagging and filtration system in communication with the remote patient monitoring apparatus via a network; and
a health care communication device, the health care communication device in communication with at least the flagging and filtration system,
wherein the remote patient monitoring apparatus is configured to:
collect patient data, the patient data comprising at least one patient measurement; and
transmit the patient data to the flagging and filtration system;
and wherein the flagging and filtration system is configured to:
receive the patient data from the remote patient monitoring apparatus;
store the patient data in the database;
flag the patient data based on the predefined rule set;
present the patient data on the health care communication device for verification by a health care professional;
update the patient data in the database to reflect any changes made during health care professional verification; and
transmit at least a portion of the patient data to a client.

12. The system of claim 11, wherein the predefined rule set includes a plurality of rules that are configurable by at least one of: a client and a user associated with the client.

13. The system of claim 11, wherein the predefined rule set includes a plurality of rules that are configurable by at least one of: the health care communication device and the health care professional.

14. The system of claim 11, wherein the predefined rule set includes a plurality of rules that are configurable by an administrator of the central processing unit.

15. A system for reviewing data, the system comprising:
a plurality of remote patient monitoring apparatuses, each remote patient monitoring apparatus including a flagging and filtration system;
a central processing unit, the central processing unit including a database, and in communication with the plurality of remote patient monitoring apparatuses;
a health care communication device, the health care communication device in communication with at least the flagging and filtration system;
wherein each remote patient monitoring apparatus is configured to:
collect patient data, the patient data comprising at least one patient measurement;
store the patient data in the database;
flag the patient data based on a predefined rule set;
present the patient data on the health care communication device for verification by a health care professional;
update the patient data in the database to reflect any changes made during health care professional verification; and
transmit at least a portion of the patient data to a client.

16. The system of claim 15, wherein the predefined rule set includes a plurality of rules defining how to categorize the patient data into one of at least three categories.

17. The system of claim 16, wherein the at least three categories includes at least: an accurate category, an inaccurate category, and a possibly inaccurate category.

18. The system of claim 15, wherein the predefined rule set includes at least one rule defining how to categorize the patient data, and the at least one rule is configurable by the client or a user associated with the client.

19. The system of claim 15, wherein presenting the patient data on the health care communication device comprises presenting an alert screen if any data in the patient data is categorized as possibly inaccurate.

20. The system of claim 15, wherein the plurality of remote patient monitoring apparatuses include at least one of: an electronic tablet, a cell phone, and an interactive voice recognition system.
